(19) United States
(12) Patent Application Publication
(10) Pub. No.: US 2018/0249073 A1
(43) Pub. Date: Aug. 30, 2018

(54) IMAGE PHOTOGRAPHING APPARATUS AND IMAGE PHOTOGRAPHING METHOD

(71) Applicant: Samsung Electronics Co., Ltd., Gyeonggi-do (JP)

(72) Inventor: Jae-gon KIM, Gyeonggi-do (JP)

(21) Appl. No.: 15/559,686

(22) PCT Filed: Dec. 3, 2015
(86) PCT No.: PCT/KR2015/013125

§ 371 Date: Sep. 19, 2017

(30) Foreign Application Priority Data
Apr. 17, 2015 (KR) 10-2015-0054325

(51) Int. Cl. H04N 5/232

(52) U.S. Cl. CPC H04N 5/23229; H04N 5/23248

(57) ABSTRACT

Provided is an image photographing method. The image photographing method comprises the steps of: obtaining a plurality of first view frames with respect to a subject at a first view point using a phase difference image sensor; obtaining a plurality of second view frames with respect to the subject at a second view point that is different from the first view point using the phase difference image sensor; comparing a plurality of first view frames and a plurality of the second view frames to calculate movement information of the second view point; and generating a light field image using the calculated movement information.

### TECHNICAL FIELD

The present invention relates to an image photographing apparatus and an image photographing method of the image photographing apparatus, and more particularly, to an image photographing apparatus and an image photographing method of the image photographing apparatus capable of generating a light field image.

### BACKGROUND ART

Among the techniques for generating a three-dimensional (3D) image with two-dimensional (2D) images based on a single camera, there is the technique called Structure-from Movement (SfM). The SfM technique estimates a 3D image based on a plurality of 2D images containing movement. This technique generates a 3D image through feature point matching between images based on some feature points in the images.

However, the SfM technology requires numerous inputs and iterations to create sophisticated 3D images. Therefore, it is very difficult to generate 3D images in real-time, and it is difficult to generate 3D images especially with an image in which feature points are not prominent, because 3D is estimated based on the feature points.

Meanwhile, in recent years, the 3D display technique, and especially the light field display has attracted attentions. The ‘light field’ is a type of field that expresses the intensity of the light in all directions from all points on a 3D space. In order to generate a light field 3D image, light field information such as a two-dimensional image, a position in 3D space from each view point, observation time, and so on is required.

In general, a 2D camera photographs an object in such a way that lights coming from a point on the object are passed through the lens and then collected and integrated at a point on the image sensor, during which information about intensity and direction of individual lights is lost, thus making acquisition of the light field information difficult.

Accordingly, a method has been developed, in which a plurality of cameras are arranged with the viewing angles overlapped so that high-resolution light field information can be obtained, or an array of micro-lenses is positioned in front of an image sensor to acquire information on separated light in each direction.

However, in the case of the camera arrangement method, the application thereof is limited due to the expensive construction cost of the system and the volume of the camera itself. The method of using the micro-lens array also suffers shortcomings such as dispersed light and subsequently reduced resolution of the image, and the field information being limited depending on the aperture width of the camera.

Accordingly, there is a need for a technique capable of generating a high-resolution light field image based on a 2D image even when the feature points are difficult to acquire.

### DETAILED DESCRIPTION OF INVENTION

### Technical Problem

The present invention has been made to solve the problems mentioned above, and accordingly, it is an object of an exemplary embodiment to provide an image photographing apparatus and an image photographing method for generating a light field image using a phase difference image sensor.

### Technical Solution

According to another aspect according to an exemplary embodiment, there is provided an image photographing method, which may include acquiring a plurality of first view frames of a subject at a first view point using a phase difference image sensor, acquiring a plurality of second view frames at a second view point different from the first view point using the phase difference image sensor, calculating movement information of the second view point by comparing each of the plurality of second frames with each of the plurality of second view frames, and generating a light field image by using the calculated movement information.

The phase difference image sensor may be a full-pixel phase difference image sensor, and the calculating the movement information may include calculating the movement information by performing an image subtraction of each of the plurality of first and second view frames.

The first view point and the second point may be varied due to at least one of Optical Image Stabilizer (OIS), a user's hand tremor, and a user's manipulation.

The phase difference image sensor may include horizontally-arranged phase difference pixels having a baseline of a preset interval. The plurality of first view frames may be left- and right-side view frames acquired at the first view point and having the baseline of the preset interval with respect to the subject. The plurality of second view frames may be left- and right-side view frames acquired at the second view point that is moved from the first view point in the horizontal direction by the present interval, and having the baseline of the preset interval with respect to the subject

The generating the light field image may include generating the light field image including the plurality of first view frames and the right-side view frame of the plurality of second view frames, when the second view point is moved to the right from the first view point, and generating the light field image including the plurality of first view frames and the left-side view frame of the plurality of second view frames, when the second view point is moved from the first view point to the left.

The phase difference image sensor may include vertically-arranged phase difference pixels having a baseline of a preset interval. The plurality of first view frames may be upper- and lower-side view frames acquired at the first view point and having the baseline of the preset interval with respect to the subject, and the plurality of second view frames may be upper- and lower-side view frames acquired at the second view point that is moved from the first view point in the vertical direction by the present interval, and having the baseline of the preset interval with respect to the subject

Further, the generating the light field image may include generating the light field image including the plurality of first view frames and the upper-side view frame of the plurality of second view frames, when the second view point is moved upward from the first view point, and generating the light field image including the plurality of first view frames and the lower-side view frame of the plurality of second view frames, when the second view point is moved downward from the first view point.

The calculating the movement information may include matching positions of the plurality of first and second view frames, and calculating the movement information by comparing the plurality of first and second view frames at the matched positions, respectively.

The calculating the movement information may include determining a degree of similarity between the plurality of first view frames and the plurality of second view frames, and when the determined degree of similarity is less than a preset value, the generating the light field image may include excluding the plurality of first and second view frames from the light field image.

The movement information may include at least one of information on a direction of movement of the second view point from the first view point, information on a distance of movement of the view point, and information on a speed of movement of the view point.

Meanwhile, an image photographing apparatus according to another exemplary embodiment is provided, which may include a photographing part configured to acquire a plurality of view frames of a subject using a phase difference image sensor, an image processing part configured to generate a light field image using the plurality of view frames photographed through the photographing part, and a control part, wherein, when the photographing part acquires a plurality of first view frames of the subject at a first view point and a plurality of second view frames of the subject at a second view point that is different from the first view point, the control part calculates movement information of the second view point by comparing each of the plurality of first view frames and each of the plurality of second view frames, and controls the image processing part to generate a light field image using the calculated movement information.

The phase difference image sensor may be a full-pixel phase difference image sensor, and the control part may calculate the movement information by performing an image subtraction of each of the plurality of first and second view frames.

The first view point and the second point may be varied due to at least one of Optical Image Stabilizer (OIS), a user's hand tremor, and a user's manipulation.

The phase difference image sensor may include horizontally-arranged phase difference pixels having a baseline of a preset interval. The plurality of first view frames may be left- and right-side view frames acquired at the first view point and having the baseline of the preset interval with respect to the subject. The plurality of second view frames may be left- and right-side view frames acquired at the second view point that is moved from the first view point in the horizontal direction by the present interval, and having the baseline of the preset interval with respect to the subject

Further, the control part may generate the light field image including the plurality of first view frames and the right-side view frame of the plurality of second view frames, when the second view point is moved to the right from the first view point, and generate the light field image including the plurality of first view frames and the left-side view frame of the plurality of second view frames, when the second view point is moved from the first view point to the left.

The phase difference image sensor may include vertically-arranged phase difference pixels having a baseline of a preset interval. The plurality of first view frames may be upper- and lower-side view frames acquired at the first view point and having the baseline of the preset interval with respect to the subject, and the plurality of second view frames may be upper- and lower-side view frames acquired at the second view point that is moved from the first view point in the vertical direction by the present interval, and having the baseline of the preset interval with respect to the subject

Further, the control part may generate the light field image including the plurality of first view frames and the upper-side view frame of the plurality of second view frames, when the second view point is moved upward from the first view point, and generate the light field image including the plurality of first view frames and the lower-side view frame of the plurality of second view frames, when the second view point is moved downward from the first view point.

Further, the control part may match positions of the plurality of first and second view frames, and calculate the movement information by comparing the plurality of first and second view frames at the matched positions, respectively.

Further, the control part may determine degree of similarity between the plurality of first view frames and the plurality of second view frames, and when the determined degree of similarity is less than a preset value, control the image processing part to generate the light field image, while excluding the plurality of first and second view frames.

The movement information may include at least one of information on a direction of movement of the second view point from the first view point, information on a distance of movement of the view point, and information on a speed of movement of the view point.

Advantageous effect

According to various exemplary embodiments as described above, it is possible to generate a high-resolution light field image based on a 2D image even when it is difficult to acquire feature points. In addition, it is possible to extend the intrinsic baseline of the phase difference image sensor, thereby enabling acquisition of a long-distance depth map.

### BRIEF DESCRIPTION OF THE DRAWINGS

FIG. 1 is a block diagram showing a configuration of an image photographing apparatus according to an exemplary embodiment.

FIG. 2 is a schematic diagram showing a configuration of a phase difference image sensor according to various exemplary embodiments.

FIG. 3 is an exemplary view showing a plurality of view frames for a subject acquired using a phase difference image sensor according to an exemplary embodiment.

FIG. 4 is an exemplary view illustrating a process of calculating movement information by comparing a plurality of first and second view frames.

FIG. 5 is a block diagram showing a configuration of an image photographing apparatus according to another exemplary embodiment.

FIG. 6 is an exemplary view illustrating a configuration of a phase difference image sensor according to various exemplary embodiments, and a plurality of view frames for a subject acquired using the same.

FIG. 7 is an exemplary diagram illustrating a light field image acquired in accordance with various exemplary embodiments.

FIG. 8 is a flowchart illustrating an image photographing method according to an exemplary embodiment.

### BEST MODE

Various exemplary embodiments will now be described in detail with reference to the accompanying drawings. In the following description, well-known functions or constructions are not described in detail since they would obscure the invention in unnecessary detail. Further, numerals (e.g., first, second, etc.) used in the description according to an exemplary embodiment are merely an identifier for distinguishing one component from another component. The suffix “part” is used in the following description to refer to certain elements, but is given or mixed in consideration only for ease of drafting the specification, and does not have a meaning or role that distinguishes itself.

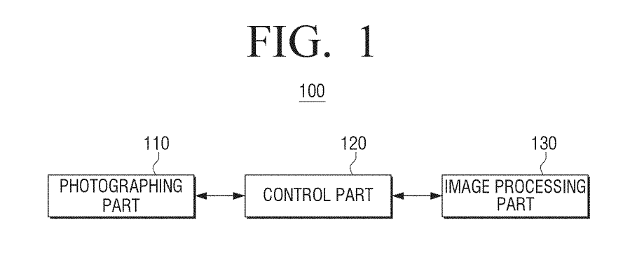

FIG. 1 is a block diagram showing a configuration of an image photographing apparatus according to an exemplary embodiment. The image photographing apparatus 100 according to various exemplary embodiments may be implemented as various electronic devices. For example, it can be implemented as any of a digital camera, an MP3 player, a PMP, a smart phone, a cellular phone, smart glasses, a tablet PC, or a smart watch.

According to FIG. 1, the image photographing apparatus 100 includes a photographing part 110, a control part 120, and an image processing part 130.

The photographing part 110 photographs a subject. The photographing part 110 may include a lens, a shutter, an iris, an image sensor, analog front end (AFE), and a timing generator (TG).

The lens (not shown) is configured to receive an incoming light that is reflected by a subject, and may include at least one of a zoom lens and a focus lens.

The shutter (not shown) adjusts the time during which light enters the image photographing apparatus 100. The amount of light accumulated in the exposed pixels of the image sensor is determined according to the shutter speed.

The iris (not shown) is configured to control the amount of light that passes through the lens and enters the image photographing apparatus 100. The iris has a mechanical structure that is capable of gradually increasing or decreasing the size of the opening so as to adjust the amount of incident light. The iris indicates a degree of openness with an aperture value called the F-number. The degree of openness is increased as the aperture value is decreased, and thus a brighter image can be generated with a greater amount of incident light.

The image sensor (not shown) is configured such that an image of a subject that has passed through the lens is converged thereon. The image sensor includes a plurality of pixels arranged in a matrix form. Each of a plurality of pixels accumulates photo charges corresponding to the incident light, and outputs an image from the photo charges as an electric signal. The image sensor may include a complementary metal oxide semiconductor (CMOS) or a charge coupled device (CCD).

The image sensor may include a photodiode PD, a transmit transistor TX, a reset transistor RX, and a floating diffusion node FD. The photodiode PD generates photo charges corresponding to the optical image of the subject and accumulates the generated photo charges. The transmit transistor TX transmits the photo charges generated in the photodiode PD to the floating diffusion node FD in response to a transmission signal. The reset transistor discharges the charges stored in the floating diffusion node FD in response to a reset signal. Before the reset signal is applied, the charges stored in the floating diffusion node FD are output, and in the case of the CDS image sensor, the correlated double sampling (CDS) processing is performed. The ADC then converts the CDS-processed analog signal into a digital signal.

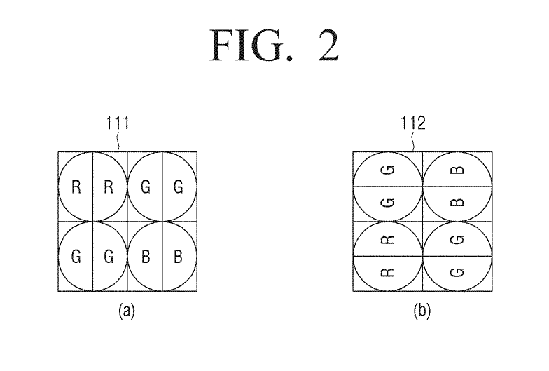

In particular, the image sensor of the photographing part 110 may include a phase difference image pixel. FIG. 2 is a schematic diagram showing a configuration of phase difference image pixels 111, 112 constituting a phase difference image sensor according to various exemplary embodiments. FIG. 2(a) shows an exemplary embodiment of a phase difference image pixel 111 in which respective R, G, G, and B sub-pixels are arranged in a horizontal direction, and FIG. 2(b) shows an exemplary embodiment of a phase difference image pixel 112 in which respective R, G, G, and B sub-pixels are arranged in a vertical direction.

When the phase difference image pixels are arranged in the horizontal direction as shown in FIG. 2(a), the incident light is acquired as two signals having different phases in the horizontal direction, and when the pixels are arranged in the vertical direction as shown in FIG. 2(b), the incident light can be acquired as two signals having different phases in the vertical direction.

Meanwhile, according to an exemplary embodiment, the image sensor of the photographing part 110 may be a phase difference image sensor in which full pixels are configured as phase difference image pixels. In this case, even when a subject is photographed at a specific view point and from a specific view point, two scenes having different points of view from each other may be acquired. That is, when a subject is photographed using a general image sensor at a specific moment, one view frame having one view point is acquired. However, when the subject is photographed using the phase difference image sensors 111, 112, a plurality of view frames having different view points from each other can be acquired. At this time, a difference of view points among a plurality of acquired view frames means an intrinsic baseline of the phase difference image sensor.

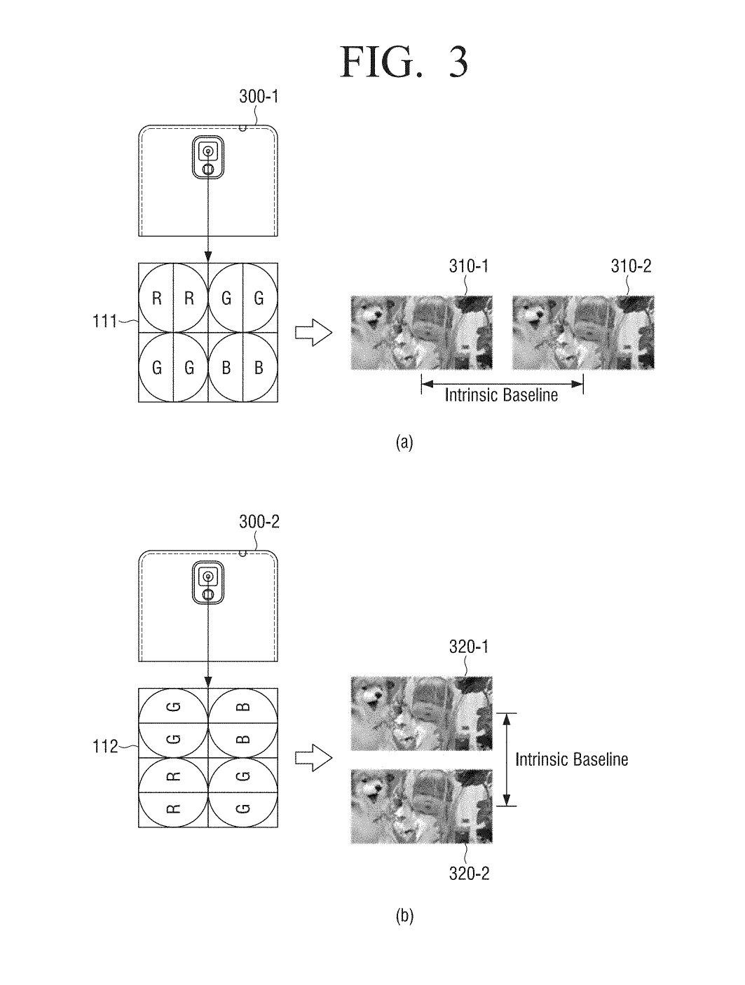

An example of a view frame acquired using a full-pixel phase image sensor is shown in FIG. 3. Referring to an example illustrated in FIG. 3(a), since the full pixels constituting the phase difference image sensor include the phase difference image pixels 111 arranged in the horizontal direction, when a subject is photographed at a certain view point (or certain location) using the image photographing apparatus 300-1, a left view frame 310-1 and a right view frame 310-2 having different view points in the horizontal direction, i.e., having different intrinsic baselines are acquired. Likewise, in the example of FIG. 3(b), since the full pixels constituting the phase difference image sensor include the phase difference image pixels 112 arranged in the vertical direction, when the subject is photographed at a certain view point (or certain location) using the image photographing apparatus 300-2, an upper view frame 320-1 and a lower view frame 320-2 having different view points in the vertical direction, i.e., having intrinsic baseline can be acquired. As described above, in the case of using the full-pixel phase image sensor, a view frame concurrently having two view points can be acquired.

According to various exemplary embodiments, as will be described below, in order to calculate the position information of the acquired view frames, a plurality of view frames at a specific view point and a plurality of view frames at another view point moved from the specific view point are necessary. Considering a possibility that a minute movement such as hand tremor of a user, or the like can be used during movement from one view point to another view point, the image sensor with a large frame per second (FPS) value may be used, in which FPS indicates the number of frames that can be acquired per second. For example, the image sensor may have an FPS of 240 or higher, but not limited thereto.

The timing generator (TG) outputs a timing signal for reading out the pixel data of the image sensor. The TG is controlled by the control part 120.

The analog front end (AFE) samples and digitizes an electric signal on the subject outputted from the image sensor. The AFE is controlled by the control part 120. Note that the AFE and the TG may be designed as another configuration that can be replaced. The configuration may be unnecessary particularly when the image sensor is implemented as a CMOS type.

The control part 120 controls the overall operation of the image photographing apparatus 100. In particular, the control part 120 may acquire a plurality of view frames with respect to the subject, and may control the image processing part 130 to generate a light field image based on a plurality of acquired view frames.

Specifically, the control part 120 may control the photographing part 110 to acquire a plurality of first view frames obtained by photographing a subject at a first view point, and a plurality of second view frames obtained by photographing the same subject at a second view point different from the first view point.

For example, while the user presses the shutter to photograph the subject, movement of the image photographing apparatus 100 may occur due to the shake of the user's hand or the like. The movement of the image-photographing device 100 means a change of a view point with respect to a subject. Since the image sensor included in the photographing part 100 can acquire a frame at a high speed as described above, the control part 120 can acquire multiple view frames of the subject even when the image photographing apparatus 100 is moved due to the trembling of the user.

Accordingly, the control part 120 may acquire the view frame of the subject photographed at the first view point and the view frame of the subject photographed at the second view point different from the first view point. In this case, since the image sensor included in the photographing part 110 is a full-pixel image sensor, the view frames acquired at each view points become a plurality of view frames having an intrinsic baseline.

Meanwhile, the control part 120 may calculate the movement information of the second view point from the first view point by comparing a plurality of acquired first view frames with a plurality of acquired second view frames, respectively. At this time, the calculated movement information may include at least one of the movement direction information of the second view point with respect to the first view point, the view point movement distance information, and the view point movement speed information.

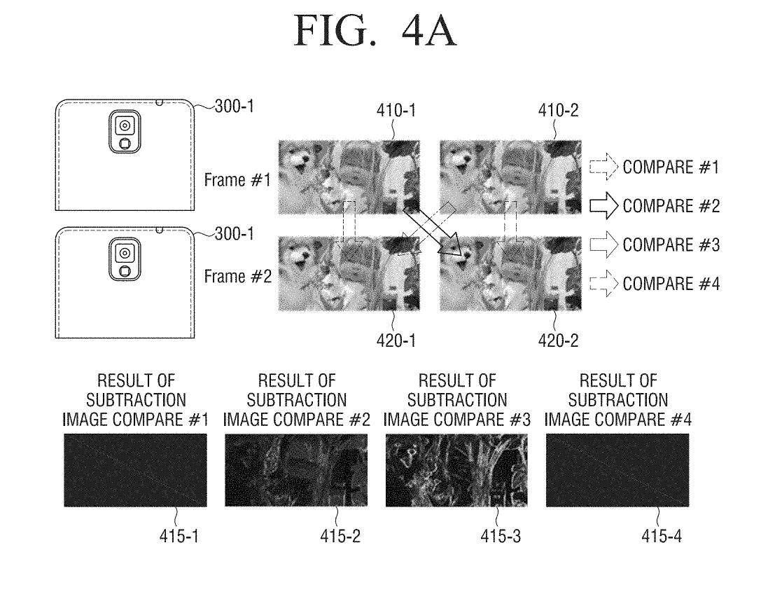

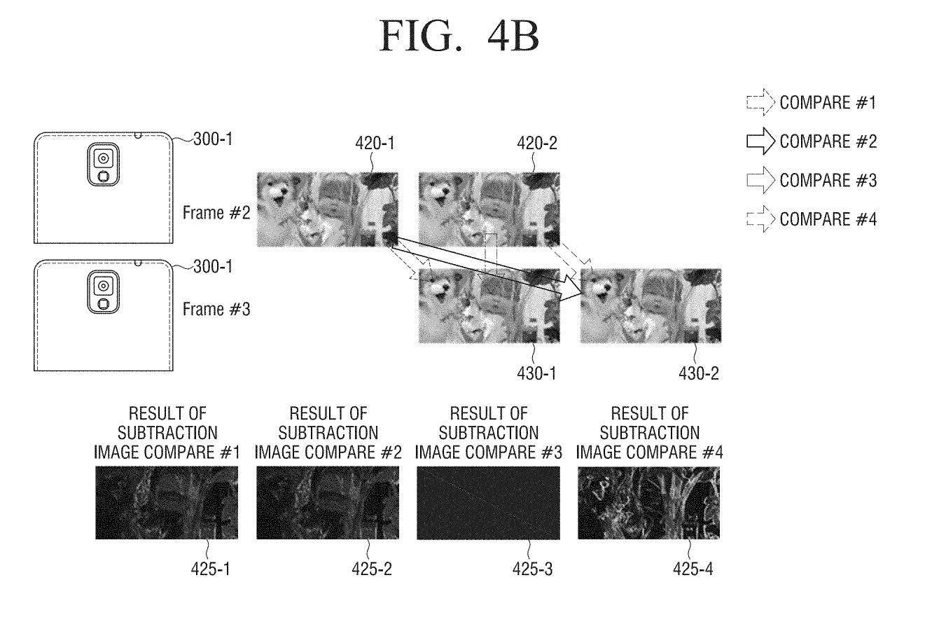

Hereinafter, the process at the control part 120 for calculating the movement information using the acquired view frames will be described in detail with reference to FIG. 4. Referring to FIG. 4, an example will be described, in which respective phase difference image pixels constituting the full-pixel phase image sensor included in the photographing part 110 are arranged in the horizontal direction.

When the user photographs the subject, the user may have hand tremor as described above, or there may be no shake. Therefore, the view point change may or may not occur while the view frames of the subject are acquired through the photographing part 110. FIG. 4a shows a case in which there is no change in the view point between acquired view frames, and FIG. 4b shows a case in which there is a change in the view point in the right direction.

For example, in response to a user's manipulation command (e.g., pressing a shutter, etc.) to photograph a subject, the control part 120 may successively acquire the view frames of the subject at FPS speed of the phase difference image sensor included in the photographing part 110. At this time, the view frames acquired at each time are a plurality of view frames having different view points, as described above.

As shown in FIG. 4a, when Frame #1, i.e., a left view frame 410-1 and a right view frame 410-2 having intrinsic baseline are acquired at a first time, and when a Frame #2, i.e., a left view frame 420-1 and a right view frame 420-2 having intrinsic baseline are acquired at a second time, the control part 120 may compare each of a plurality of acquired first view frames 410-1 with each of a plurality of second view frames 420-1, 420-2.

Specifically, the control part 120 may perform an image subtraction for the left view frame 410-1 acquired at the first time and the left and right view frames 420-1, 420-2 acquired at the second time, respectively, and perform an image subtraction for the right view frame 410-2 acquired at the first time and the left and right view frames 420-1, 420-2 acquired at the second time. In this example, there is no limitation on the type of image subtraction technique used.

Since FIG. 4a shows an example where there is no change in the view point, the left view frame 410-1 acquired at the first time and the left view frame 420-1 acquired at the second time are the same, and the right view frame 410-2 acquired at the first time and the right view frame 420-2 acquired at the second time are the same. Therefore, the image subtraction provides the same result for comparison #1 415-1 and comparison #4 415-4. On the other hand, since there is intrinsic baseline between the two view frames 410-1 and 410-2, 420-1 and 420-2 acquired at the same time, the same result as comparison #2 415-2 and comparison #3 415- 3 is obtained.

That is, when there is no change in the view point between the previous view frame (Frame #1) and the current view frame (Frame #2) acquired through the photographing part 110 (for example, when there is no movement of the image photographing apparatus 100), the same result as the result of image subtraction 415-1 to 415-4 in FIG. 4a is always acquired.

Accordingly, the control part 120 may compare a plurality of previous view frames 410-1, 410-2 with a plurality of current view frames 420-1, 420-2, and determine that there is no change in the view point between the acquired previous view frame (Frame #1) and the current view frame (Frame #2), when the result same as the image subtraction results 415-1 to 415-4 is obtained.

Meanwhile, after Frame #2 is acquired at the second time, the next view frame, i.e., Frame #3 (i.e., left view frame 430-1 and right view frame 430-2 having the intrinsic baseline) is obtained at a third time, as shown in the example of FIG. 4b. Accordingly, the control part 120 may perform an image subtraction for the left view frame 420-1 acquired at the second time and the left and right view frames 430-1, 430-2 acquired at the third time, respectively, and perform image subtraction for the right view frame 420-2 acquired at the second time and the left and right view frames 430-1, 430-2 acquired at the second time, respectively.

In this case, it can be expected that the result of the image subtraction will be obtained as shown in comparison #1 425-1 through comparison #4 425-4. Particularly, since Frame #3 has moved to the right by the intrinsic baseline of the phase difference image sensor based on Frame #2, the right view frame 420-2 of Frame #2 and the left view frame 430-1 of Frame #3 are the view frames of the same view point. Therefore, as shown in the comparison #3 425-3, the result of the image subtraction indicates that the right view frame 420-2 of Frame #2 and the left view frame 430-1 of Frame #3 have the least change.

Therefore, when the result such as the image subtraction results 425-1 to 425-4 in FIG. 4B is obtained, the control part 120 may determine that the current view frame (Frame #3) is moved from the previous view frame (Frame #2) to the right by the intrinsic baseline so that the view point is changed.

If the image subtraction result shows that there is the least change in comparison #2 425-2, it may be determined that the current view frame is moved from the previous view frame by the intrinsic baseline in the left direction so that the view point is changed.

The process described above shows that information about whether the view point is moved or not, a direction of movement, a distance of movement, and a speed of movement can be calculated using the view frames of the subject acquired during the photographing of the subject. Specifically, in the case of FIG. 4a, the control part 120 may determine that there is no view point, and in the case of FIG. 4b, the control part 120 may determine that the view point has moved to the right.

In addition, since the view frames acquired through the photographing part 110 are two views frames having intrinsic baseline, in an example as shown in FIG. 4b, the control part 120 may determine that the view point has moved by a distance corresponding to the intrinsic baseline. Further, since the phase difference image sensor has a particular FPS, the control part 120 may calculate information on the movement speed, by dividing the distance for which the view point has moved by the time interval at which the view frames are acquired. In the manner described above, the control part 120 may compare the view frames successively acquired by the photographing part 110 according to the FPS of the phase difference image sensor, to thus calculate the movement information of the view point.

Meanwhile, when the user is photographing a subject by using the image photographing apparatus 100, the hand trembling of the user may not necessarily occur in parallel in the lateral direction. That is, rather than an ideal example where the view point is moved and the view frames acquired, a change may occur as only portions of Frames #2 and #3 overlap, or as vertical movement or rotation is generated, as shown in FIG. 4b. Accordingly, in order to remove the error in the view point movement as described above, the control part 120 may acquire the movement information by matching the positions of the view frames acquired through the photographing part 110, and comparing the view frames at the matched positions with each other. To this end, the control part 120 may match the positions of the view frames by using Digital Image Stabilizer (DIS) algorithm, but not limited thereto.

Further, by using a phase difference image sensor with the high FPS, it is possible to minimize the error in the movement of a view point between the previous frame and the current view frame. Thus, the higher the FPS of the phase difference image sensor becomes, the need to utilize the DIS is reduced and the time for matching the view frames is reduced, so that a light field image can be generated in a short time.

Meanwhile, since each of the successive view frames acquired through the photographing part 110 are acquired by using a phase difference image sensor, the view frames will apparently be a plurality of view frames having an intrinsic baseline.

Meanwhile, the control part 120 may the calculated movement information to control the image processing part 130 to generate a light field image. Specifically, the control part 120 may use the calculated movement information to select the view frames to be used for generating a light field image and control the image processing part 130 to generate the light field image using the selected view frames.

The control part 120 may use the calculated movement information to determine a movement distance of the view point of each of the view frames acquired successively by the image photographing part 110 and also a direction of the movement of the view point of each of the view frames from the view point of the previous view fame. Accordingly, the control part 120 may select a reference view frame among the view frames acquired successively by the phase difference image sensor, and select the view frames whose view points are moved by intervals corresponding to the intrinsic baseline of the phase difference image sensor. In this example, the reference view frame may be the one at the reference view point constituting the light field image, and may be the first view frame that is acquired through the photographing part 110 in accordance with the user's command to photograph, but not limited thereto.

Accordingly, from among the selected view frames, the control part 120 may select the view frames to be used in generating a light field image, while excluding one of overlapping view frames (i.e., view frames at a same view point).

For example, referring to the example of FIG. 4 in which Frames #1, #2 and #3 are successively acquired and Frame #1 is a reference frame, Frame #2, which is not the view frame whose view point is moved from the view point of Frame #1 by the intrinsic baseline, is excluded, while Frame #3, which is the view point whose view point is moved from Frame #2 to the right as much as the intrinsic baseline, is selected. The control part 120 may then select the view frames to be used for generating a light field image, which may be the view frames 410-1, 410 2, 430-2 constituting Frames #1 and #3 but excluding the left view frame 430-1 of Frame #3 which is overlapping view frame.

If the view point of Frame #3 is moved to the left from Frame #2 by the intrinsic baseline, then among the reference view frames 410-1, 410-2, the left-side view frame 410-1 will overlap the right-side view frame 430-2 of Frame #3. Accordingly, the control part 120 may select the view frames to be used for generating a light field image, i.e., may select the view frames 410-1, 420-1, 430-1, but excluding the overlapping view frame 430-2.

Accordingly, the control part 120 may control the image processing part 130 to generate a light field image using the view frames selected to be used for generating the light field image.

Meanwhile, the control part 120 may generate a depth map for the light field image, using the view frames to be used for generating the light field image and the movement information of the respective view frames.

‘Depth’ is information indicating the 3D image depth, and it is the information corresponding to the degree of baseline between the left- and right-side view frames of a 3D image frame. A person feels a varying degree of three-dimensional effect depending on the depth. That is, when the depth is greater, the baseline between left and right sides becomes larger, thus leading to a relatively greater sense of three dimension, while when the depth is smaller, the baseline between left and right sides becomes smaller, thus leading to a relatively less sense of three dimension.

Depth map is a table containing the depth information of each region of 3D image. The region may be divided into pixels and may be defined as a predetermined region larger than the pixel unit. The ‘depth’ herein may be a depth of each region or pixel of the 3D image frame. In one embodiment, the depth map may correspond to a two-dimensional image of a grayscale that expresses the depth for each pixel in the image frame.

The intrinsic baseline of the phase difference image sensor used herein is a very short distance, and thus has accurate pixel information about a subject. This is because very small baseline can acquire raw image data close to 2D image data, and thus has very little loss of image data for the subject.

In particular, since the loss of data at a boundary area of the subject is low in the depth map acquired through the raw image data, it is possible to obtain the depth map information having a clear silhouette. In addition, since view frames are acquired, whose view points are moved by the intrinsic baseline of the phase difference image sensor, the baseline is extended by the unit of intrinsic baseline, thus allowing easy distance estimation. Further, since the phase difference image sensor is used for full pixels, it is possible to acquire 3D information for the entire pixels of the view frames and thus generate highly accurate depth map with a less number of view frames.

Meanwhile, according to an embodiment, the control part 120 may determine the similarity between the view frames that are acquired successively by the photographing part 110, and when the similarity between the previous view frame and the current view frame is less than a predetermined value, the control part 120 may control the image processing part to generate a light field image, while excluding the two view frames for which the similarity is determined. That is, when determining that the difference between the view frames is too large such that there is no similarity, the control part 120 may select the view frames to be used for generating a light field image while excluding such view frames. In this case, the control part 120 may select a reference view frame again.

Meanwhile, the control part 120 may include hardware configuration such as a CPU, cache memory, and so on, and software configuration such as operating system, applications to perform a specific purpose, and so on. According to the system clock, the control command to each component of the image photographing apparatus 100 is read from the memory, and the respective hardware components may be operated according to an electric signal generated in accordance with the read control command.

Specifically, the image processing part 130 may process the raw image data photographed by the photographing part 110 to create a YCbCr data. In addition, it may determine an image black level and adjust color-sensitivity. In addition, the image processing part 130 may adjust the white balance, and perform gamma correction, color interpolation, color correction, and resolution conversion.

In particular, the image processing part 130 may be controlled by the control part 120 to use the view frames acquired through the photographing part 110 to generate a light field image. Specifically, the image processing part 130 may generate a light field image, using the view frames used for generating the light field image selected by the control part 120, and the movement information of the corresponding view frames and the depth map calculated at the control part 120. In this example, the view frames used for generating the light field image are those that are acquired successively in time and therefore, the resolution is not reduced, unlike the method using a conventional micro-lens array.

Meanwhile, although not shown in the drawings, the image photographing apparatus 100 may of course store in the storage (not illustrated) the data such as all the data of the view frames described above, information on movement of view points of respective view frames, image subtraction result, the depth map information, and so on, and perform the operations described above as necessary by reading out the data from the storage.

Although an example is described above, in which each phase difference image pixel constituting the full-pixel phase difference image sensor included in the image photographing part 110 is arranged in a horizontal direction, the same method is still applicable even when each phase difference image pixel is arranged in the vertical direction, because the only difference is whether the view point is moved in the horizontal direction or vertical direction.

For example, with the phase difference image sensor configured with phase difference pixels arranged in a vertical direction having an intrinsic baseline, when the view frames for a subject having an intrinsic baseline in the vertical direction are successively acquired as shown in FIG. 3(b), the control part 120 may acquire the movement information of the view point by the image subtraction of the respective acquired view frames, select the view frames to be used for generating a light field image using the calculated movement information, select a depth map for the selected view frames, and then control the image processing part 130 to generate a light field image.

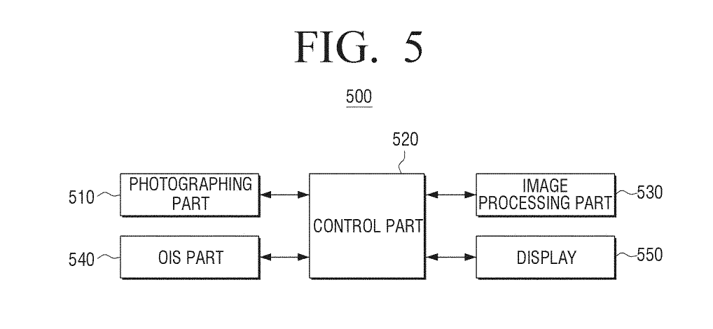

FIG. 5 is a block diagram showing the configuration of the image photographing apparatus according to another exemplary embodiment. In the following description of FIG. 5, the overlapping operations of the components identical to those described above with reference to FIGS. 1 to 4 will not be described in detail below. In particular, the photographing part 510, the control part 520, and the image processing part 530 will not be redundantly described below, as these are almost identical to the photographing part 110, the control part 120 and image processing part 130 described above with reference to FIG. 1.

According to FIG. 5, the image photographing apparatus 500 may include a photographing part 510, a control part 520, an image processing part 530, an Optical Image Stabilizer (OIS) part 540 and a display part 550.

The OIS is a technique for correcting an image shake due to the movement caused by the unstable fixing or holding of the image photographing apparatus, and the OIS part 540 may correct the image shake resulted from the shaking of the image photographing apparatus 500. To this end, the OIS part 540 may include a shake sensing part (not shown) and a shake correcting part (not shown).

The shake sensing part is configured to sense a shake of the image photographing apparatus 500 due to user's hand tremor or the like that occurs during photographing of a subject with the image photographing device 500. The shake sensing part senses it when the image photographing apparatus 500 shakes to generate information such as direction distance, speed, or the like of such shaking and provide the same to the shake correcting part. The shake correcting part may use the information provided from the shake sensing part to move the image sensor included in the image photographing part 510 in a direction opposite the direction of shaking of the image photographing apparatus and correct the shake of the image photographing apparatus 500.

In particular, in response to a user's manipulation command to photograph inputted in the photographing mode for generating a light field image, the OIS part 540 under the control of the control part 520 may move the view point of the view frames successively acquired for the subject by moving the phase difference image sensor included in the photographing part 510. That is, even in situations where there is no movement of the image photographing apparatus 500 from the user's hand tremor, as described above in FIGS. 1 to 4, the control part 520 may controls the shake correcting part included in the OIS part 540 to thus move the view point for photographing a subject.

The display part 550 may display a variety of images, and Graphic User Interface (GUI). In particular, the display part 550 may display a light field image provided by the image processing part 530.

Further, the display part 550 may display a guiding GUI for guiding a manipulation of moving the image photographing apparatus 500 to a specific direction. Therefore, even when there is no hand tremor or movement of a view point through the OIS part 510, while the user is photographing a subject, he or she may perform a manipulation of moving a position of the image photographing apparatus 500 according to the guiding GUI to thus move the view point of the view frames that are successively acquired for the subject. For example, the guiding GUI may be provided in a text form, such as “Move the camera slowly in a horizontal direction,” “Move the camera in a vertical direction,” or the like depending on the direction of arrangement of the phase difference image pixels constituting a phase difference image sensor, but not limited thereto. Accordingly, in another example, the guiding GUI may be provided in a form of voice output.

In order to generate a light field image using the various exemplary embodiments, it is essential that the view point of the view frames, which are successively acquired from the subject, be moved according to the FPS of the phase difference image sensor. It will be understood that movement of view point may be performed using the movement of the image photographing apparatus 100 caused by the user's hand tremor, or by using the OIS part 510, or by using the manipulation of the user who is guided by the guiding UI. However, the present disclosure is not limited to any of specific examples, and accordingly, any method that can change the view point during successive acquisition of view frames of the subject is applicable.

Meanwhile, the image photographing apparatus 100, 500 according to various embodiments may further include a configuration of an electronic device for the conventional image photographing and processing, in addition to the configuration described above. That is, the additional configuration may include a motor driver to drive the focusing lens to focus, SDRAM to store the raw image data, intermediate image data and final image data, a flash memory to store firmware programs, adjustment information conforming to the specifications of the image photographing apparatus 100, 500, setting information of the image photographing apparatus 100, 500 as inputted by the user, etc., a JPEG codec to compress YCbCr data, a communicating part to transmit and receive image data, a USB module, a HDMI module, and an MHL module, which are capable of transmitting and receiving data to and from an external device in a wired manner, a memory card detachably mountable to a device, a display part to display a user interface configured with texts, icons, and so on, a subject, image photographing apparatus information, live view or photographed images, an electronic viewfinder, an input including at least one button, touch screen, proximity sensor, or the like for receiving a user input, a power supply to supply power, and a housing accommodating therein the components described above. Further, the storage may store the operating system, applications, firmware, and so on for performing the operations described above.

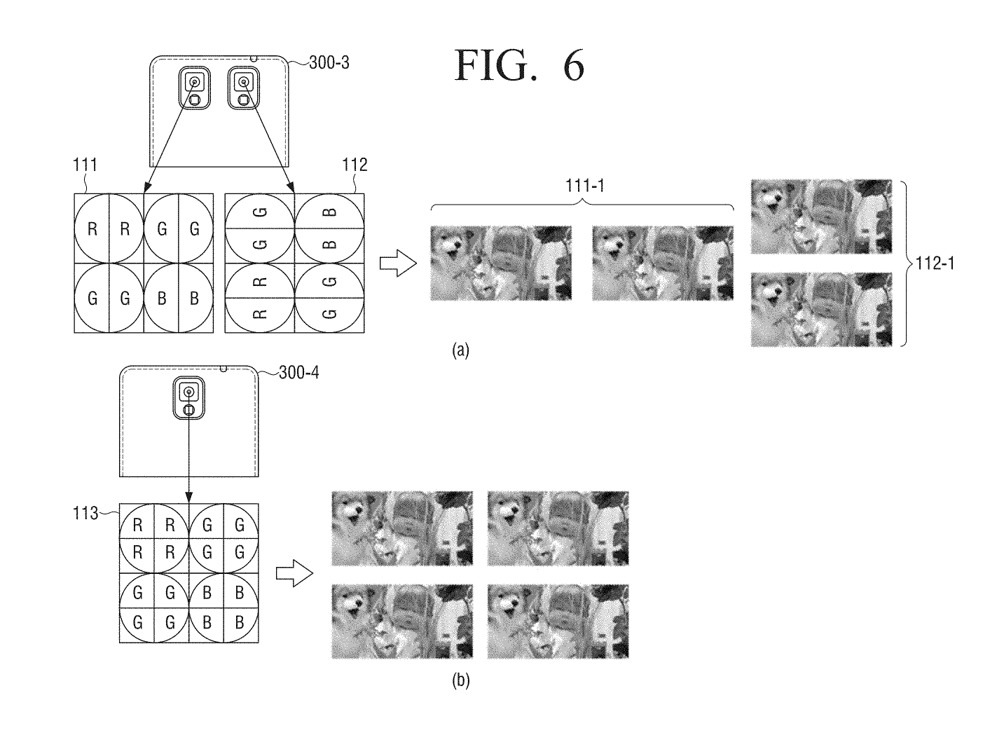

The example has been described above, in which the phase difference image sensor included in the image photographing part 110, 510 is configured with phase difference image pixels arranged in the horizontal direction or the vertical direction. However, the embodiment is not limited to the phase difference image sensor included in the image photographing part 110, 510. FIG. 6 illustrates a configuration of the phase difference image sensor according to various embodiments, and view frames with intrinsic baselines, acquired by using the phase difference image sensor.

FIG. 6(a) illustrates an example of an image photographing apparatus 300-3 including a photographing part that includes a phase difference image sensor configured with horizontally-arranged phase difference image pixels 111, and a photographing part that includes a phase difference image sensor configured with vertically-arranged phase difference image pixels 112, respectively. In this example, the photographing part including the phase difference image pixels 111 acquires the view frames having an intrinsic baseline in the horizontal direction as indicated by the reference numerals 111-1, and the photographing part including the phase difference image pixels 112 acquires the view frames having an intrinsic baseline in the vertical direction as indicated by the reference numeral 111-2, respectively.

FIG. 6(b) shows an example in which the R, G, G, B sub-pixels each constituting the phase difference image pixels are arranged in horizontal and vertical directions so as to have four phase differences. When the phase difference image sensor included in the image photographing part of the image photographing apparatus 300-4 is configured with phase difference image pixels 113 in such a form that is indicated by reference numeral 113, it is seen that the acquired view frames have different intrinsic baselines in horizontal and vertical directions.

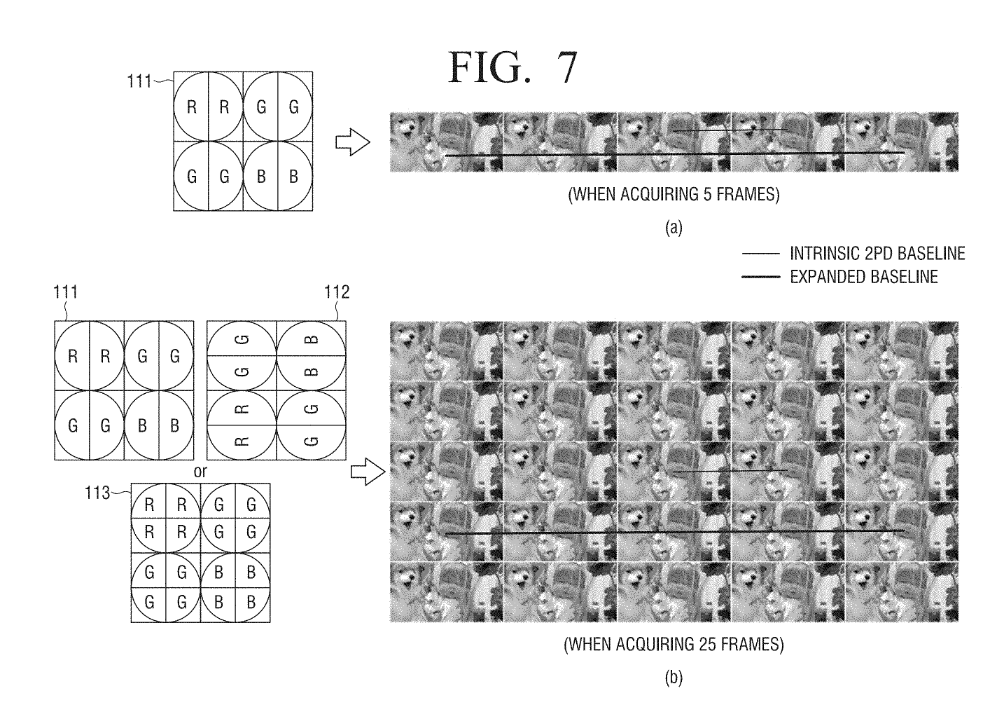

FIG. 7 is an exemplary view showing a light field image generated by the image photographing apparatus 100, 500 in accordance with various embodiments described above. FIG. 7(a) illustrates an example in which the phase difference image sensor configured with the horizontally-arranged phase difference image pixels 111 is used for acquiring the view frames of the subject, and shows an example of the view frames selected to be used for generating a light field image by the control part 120, 520. As illustrated, when five view frames are selected, it can be seen that the baseline is extended five times greater, compared to the intrinsic baseline of the phase difference image sensor.

FIG. 7(b) shows an example of the view frames to be used to generate a light field image, which are acquired using the phase difference image sensor according to the example of FIG. 6. Because the phase difference image sensor according to the example of FIG. 6 acquires view frames having intrinsic baseline in not only the horizontal direction, but also the vertical direction, it can be seen that 25 view frames can be selected as illustrated. At this time, it can be noted that the baseline is extended five times greater than the intrinsic baseline in the vertical direction and the horizontal direction.

The control part 120, 520 may control the image processing part 130 to generate a 3D light field image using the view frames selected as described above. The generated 3D light field image may be displayed on the display part 550.

Meanwhile, in the example described above, it is described that the control part 120, 520 selects the view frames to be used for generating a light field image and the image processing part 130 accordingly generates the 3D image (i.e., light field image) using the selected view frames. However, embodiment is not limited thereto, and accordingly, the respective view frames illustrated in FIG. 7 may be referred to as the light field images.

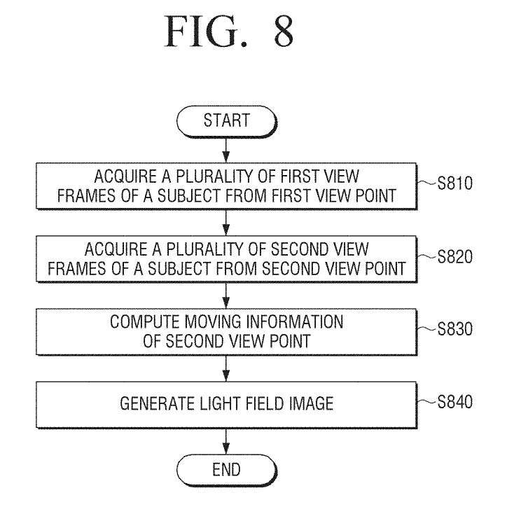

FIG. 8 is a flow chart showing an image photographing method according to an exemplary embodiment. In describing the image photographing method with reference to FIG. 8, the elements or operations overlapping with those already described above with reference to FIGS. 1 to 7 will not be redundantly described below.

Referring to FIG. 8, an image photographing apparatus 100, 500 may acquire a plurality of first view frames of a subject at a first view point by using the phase difference image sensor, at S810, and acquire a plurality of second view frames of the subject at a second view point different from the first view point, at S820.

In this example, the phase difference image sensor may be the full-pixel phase difference image sensor in which the entire pixels include phase difference image pixels. Meanwhile, when the subject is photographed using the phase difference image sensor, the first and second view frames are defined as a plurality of view frames, by considering that a plurality of view frames with different view points from each other can be acquired at the first view point and the second view point, respectively, due to the intrinsic baseline of the phase difference image sensor. In other words, this means that, when the subject is photographed with the phase difference image sensor, and when the image photographing apparatus 100 or the image sensor is moved (i.e., when the view point is moved), a plurality of view frames having intrinsic baseline are acquired in each of the successively-acquired view frames according to the Frame Per Second (FPS) of the phase difference image sensor. In this example, the movement from the first view point to the second view point may be achieved by at least one of the Optical Image Stabilizer (OIS), the hand tremor of the user, or the manipulation by the user, although not limited thereto.

In this way, at S830, the image photographing apparatus 100, 500 may compare a plurality of first view frames and a plurality of second view frames as acquired, to thus calculate the movement information of the second point from the first point. Specifically, the image photographing apparatus 100, 500 may calculate the movement information by performing the image subtraction with the previously-acquired view frames and the view frames constituting the current view frames. At this time, the image subtraction that can be used is not limited to a specific technique, and accordingly, any algorithm is applicable as long as the algorithm provides the information about the direction of movement of the view point of the view frame from the view point of the previous view frame, and the moving distance of the view point. The calculated movement information may include at least one of information on the direction of movement of the view point of the plurality of second view frames from the plurality of first view frames, information on the distance of movement of the view point, and information on the speed of movement of the view point.

Meanwhile, according to an exemplary embodiment, when calculating the movement information, the image photographing apparatus 100, 500 may match the positions of the plurality of first and second view frames using Digital Image Stabilizer (DIS) algorithm and so on, and compare the plurality of first and second view frames to calculate the movement information.

Accordingly, the image photographing apparatus 100 500 generates a light field image by using the calculated movement information, at S840. Specifically, using the calculated movement information, the image photographing apparatus 100 500 may select the view frames to be used to generate a light field image, and generate a depth map for each of the selected view frame, and generate a final 3D light field image.

In this example, the image photographing apparatus 100 500 may determine the degree of similarity between the successively-acquired view frames, and when determining that the similarity is less than a set value, may generate a light field image while excluding two view frames that have the similarity less than the set value.

For example, when a user desires to generate a light field image of a subject using the phase difference image sensor configured with horizontally-arranged phase difference pixels having an intrinsic baseline, in response to a user's command to photograph inputted to the image photographing apparatus 100, 500, left- and right-side view frames having intrinsic baseline to the subject may be acquired at the first view point, at S810.

Then, at S820, when the view frames are acquired at the second view point that is moved from the first view point to the right by a distance corresponding to the intrinsic baseline of the phase difference image sensor, due to user's hand tremor, manipulation, or the OIS, the image photographing apparatus 100, 500 may calculate the movement information of the second view point and thus knows that the second view point is moved from the first view point to the right by the intrinsic baseline, at S830. Accordingly, the image photographing apparatus 100, 500 may generate a light field image that includes the left- and right-side view frames acquired at the first view point, and the left-side view frame acquired at the second view point, at S840.

If, at S820, the view frames are acquired at the second view point moved by an intrinsic baseline to the left from the first view point, the image photographing apparatus 100, 500 may calculate the movement information of the second view point, and thus know that the second view point is moved from the first view point to the left by the intrinsic baseline, at S830.

Accordingly, the image photographing apparatus 100, 500 may generate a light field image that includes the left- and right-side view frames acquired at the first view point, and the right-side view frame acquired at the second view point, at S840.

It is apparent that the image photographing apparatus 100, 500 may generate a light field image in the similar manner to that described above, even when the user desires to generate a light field image of the subject using the phase difference image sensor configured with the vertically-arranged phase difference pixels having an intrinsic baseline.

According to various exemplary embodiments as described above, even when it is difficult to acquire the feature point, a high resolution light field image can still be generated based on the 2D images. In addition, since it is possible to extend the intrinsic baseline of the phase difference image sensor, a long-distance depth map can be acquired.

Meanwhile, various applications are of course possible by using the light field image generated in accordance with various exemplary embodiments described above. For example, natural Refocus function may be performed, and it is also possible to improve resolution by the Plenoptic 2.0 algorithm.

Meanwhile, operations and the image photographing methods of the control part 120 of the image photographing apparatus described above according to various embodiments described above may be generated as software and installed in the image photographing apparatus.

For example, a non-transitory computer readable medium may be installed, storing therein programs for executing an image photographing method comprising: acquiring a plurality of first view frames of the subject at a first view point by using a phase difference image sensor; acquiring a plurality of second view frames of the subject at a second view point different from the first view point by using the phase difference image sensor; calculating movement information of the second view point by comparing each of the plurality of view frames and each of the plurality of second view frames, respectively; and generating a light field image by using the calculated movement information.

The non-transitory computer readable medium refers to a medium that stores data semi-permanently and that can be read by the device, rather than a register, a cache, or a memory that stores data for a short time Specifically, various middleware or programs described above may be stored and provided on a non-transitory computer readable media, such as CD, DVD, hard disk, a Blu-ray disk, a USB, a memory card, ROM.

The above description provides the technical scope of the present disclosure by way of example, and those skilled in the art will be able to make various modifications and changes without departing from the essential characteristics of the present disclosure. Further, the embodiments are described herein not to limit, but to explain the technical scope of the present disclosure, and the technical scope of the present disclosure is not limited by such embodiments. Accordingly, the scope of the invention should be construed by the following claims, and all the technical spirit within the equivalent scope will be construed as included in the scope of the present disclosure.

1. An image photographing method, comprising:
acquiring a plurality of first view frames of a subject at a first view point using a phase difference image sensor;
acquiring a plurality of second view frames at a second view point different from the first view point using the phase difference image sensor;
calculating movement information of the second view point by comparing each of the plurality of second frames with each of the plurality of second view frames; and
generating a light field image by using the calculated movement information.

2. The image photographing method according to claim 1, wherein the phase difference image sensor is a full-pixel phase difference image sensor, and the calculating the movement information comprises calculating the movement information by performing an image subtraction of each of the plurality of first and second view frames.

3. The image photographing method according to claim 1, wherein the first view point and the second point are varied due to at least one of Optical Image Stabilizer (OIS), a user's hand tremor, and a user's manipulation.

4. The image photographing method according to claim 1, wherein the phase difference image sensor comprises horizontally-arranged phase difference pixels having a baseline of a preset interval,
the plurality of first view frames are left- and right-side view frames acquired at the first view point and having the baseline of the preset interval with respect to the subject, and
the plurality of second view frames are left- and right-side view frames acquired at the second view point that is moved from the first view point in the horizontal direction by the present interval, and having the baseline of the preset interval with respect to the subject.

5. The image photographing method according to claim 4, wherein the generating the light field image comprises generating the light field image including the plurality of first view frames and the right-side view frame of the plurality of second view frames, when the second view point is moved to the right from the first view point, and
generating the light field image including the plurality of first view frames and the left-side view frame of the plurality of second view frames, when the second view point is moved from the first view point to the left.

6. The image photographing method according to claim 1, wherein the phase difference image sensor comprises vertically-arranged phase difference pixels having a baseline of a preset interval,
the plurality of first view frames are upper- and lower-side view frames acquired at the first view point and having the baseline of the preset interval with respect to the subject, and
the plurality of second view frames are upper- and lower-side view frames acquired at the second view point that is moved from the first view point in the vertical direction by the present interval, and having the baseline of the preset interval with respect to the subject

7. The image photographing method according to claim 6, wherein the generating the light field image comprises generating the light field image including the plurality of first view frames and the upper-side view frame of the plurality of second view frames, when the second view point is moved upward from the first view point, and
generating the light field image including the plurality of first view frames and the lower-side view frame of the plurality of second view frames, when the second view point is moved downward from the first view point.

8. The image photographing method according to claim 1, wherein the calculating the movement information comprises:
matching positions of the plurality of first and second view frames; and
calculating the movement information by comparing the plurality of first and second view frames at the matched positions, respectively.

9. The image photographing method according to claim 1, wherein the calculating the movement information comprises determining a degree of similarity between the plurality of first view frames and the plurality of second view frames, and
when the determined degree of similarity is less than a preset value, the generating the light field image comprises excluding the plurality of first and second view frames from the light field image.

10. The image photographing method according to claim 1, wherein the movement information comprises at least one of information on a direction of movement of the second view point from the first view point, information on a distance of movement of the view point, and information on a speed of movement of the view point.

11. An image photographing apparatus, comprising:
a photographing part configured to acquire a plurality of view frames of a subject using a phase difference image sensor;
an image processing part configured to generate a light field image using the plurality of view frames photographed through the photographing part; and
a control part, wherein, when the photographing part acquires a plurality of first view frames of the subject at a first view point and a plurality of second view frames of the subject at a second view point that is different from the first view point, the control part calculates movement information of the second view point by comparing each of the plurality of first view frames and each of the plurality of second view frames, and controls the image processing part to generate a light field image using the calculated movement information.

12. The image photographing apparatus according to claim 11, wherein the phase difference image sensor is a full-pixel phase difference image sensor, and the control part calculates the movement information by performing an image subtraction of each of the plurality of first and second view frames.

13. The image photographing apparatus according to claim 11, wherein the first view point and the second point are varied due to at least one of Optical Image Stabilizer (OIS), a user's hand tremor, and a user's manipulation.

14. The image photographing apparatus according to claim 11, wherein the phase difference image sensor comprises horizontally-arranged phase difference pixels having a baseline of a preset interval,
the plurality of first view frames are left- and right-side view frames acquired at the first view point and having the baseline of the preset interval with respect to the subject, and
the plurality of second view frames are left- and right-side view frames acquired at the second view point that is moved from the first view point in the horizontal direction by the present interval, and having the baseline of the preset interval with respect to the subject.

15. The image photographing apparatus according to claim 14, wherein the control part generates the light field image including the plurality of first view frames and the right-side view frame of the plurality of second view frames, when the second view point is moved to the right from the first view point, and
generates the light field image including the plurality of first view frames and the left-side view frame of the plurality of second view frames, when the second view point is moved from the first view point to the left.
